(19) United States
(12) Patent Application Publication
(10) Pub. No.: US 2025/0296363 A1
(43) Pub. Date: Sep. 25, 2025

(54) INK JET RECORDING APPARATUS

(71) Applicant: CANON KABUSHIKI KAISHA, Tokyo (JP)

(72) Inventors: TOMOKI NAKANO, Chiba (JP); SHIMON KADOYA, Chiba (JP); HIROKI KAJITA, Saitama (JP); SHUTARO SAITO, Tokyo (JP); KOHEI AOKI, Chiba (JP); TAKUMA TADOMI, Chiba (JP); YUTARO OKADA, Chiba (JP); HIROSHI KOKUBO, Tokyo (JP); NOBUYUKI YOMODA, Chiba (JP); YUSHI SADAMITSU, Tokyo (JP)

(21) Appl. No.: 19/079,728

(22) Filed: Mar. 14, 2025

(30) Foreign Application Priority Data
Mar. 19, 2024 (JP) 2024-044088

(51) Int. Cl. B41J 11/00; B41J 29/377

(52) U.S. Cl. CPC B41J 11/00242; B41J 29/377

(57) ABSTRACT

An ink jet recording apparatus includes a fixing portion including a first belt, a second belt, and a heating portion, a cooling portion disposed downstream of the fixing portion in a conveying direction of the recording material and including a cooling fan, a partition wall separating a first chamber in which the fixing portion is disposed and a second chamber in which the cooling portion is disposed from each other, and including a communication port, a guide portion, a blowing fan disposed above the guide portion in the first chamber, and an exhaust fan configured to exhaust the air blown from the blowing fan via the communication port to the second chamber, the exhaust fan being disposed upstream of the cooling portion in the conveying direction of the recording material in the second chamber.

### BACKGROUND OF THE INVENTION

### Field of the Invention

The present invention relates to an ink jet recording apparatus that forms an image with ink.

### Description of the Related Art

In an ink jet recording apparatus that forms an image on a recording material with ink, a method that uses a pair of heating belts that come into contact with each other is known as a method for fixing the ink on the recording material. Japanese Patent Application Laid-Open Publication No. 2020-15290 discloses that a pair of heating belts are used to secure a long fixing nip portion for nipping and conveying a recording material and fixing ink onto the recording material. Moisture or a solvent contained in the ink is vaporized by heating. In a case where ink is fixed onto a recording material by a pair of heating belts, the moisture or solvent in the ink vaporized by heat in the fixing nip portion may condense when the temperature inside the device drops. In the conveying direction of the recording material, a conveyance guide for guiding the recording material that has passed through the fixing nip portion is disposed downstream of the pair of heating belts, and when dew condensation occurs, moisture or a solvent adheres to the conveyance guide. When moisture or a solvent adheres to the conveyance guide, the recording material may become dirty or the recording material may jam.

### SUMMARY OF THE INVENTION

According to one aspect of the present invention, an ink jet recording apparatus includes a fixing portion including a first belt, a second belt contacting the first belt to form a nip portion, and a heating portion configured to heat the first belt, and configured to fix the ink to a recording material on which an image is formed with ink while conveying and heating by the nip portion, a cooling portion disposed downstream of the fixing portion in a conveying direction of the recording material and including a cooling fan configured to blow air onto the recording material conveyed from the fixing portion to cool the recording material, a partition wall separating a first chamber in which the fixing portion is disposed and a second chamber in which the cooling portion is disposed from each other, and including a communication port configured to communicate between the first chamber and the second chamber such that the recording material passes through, a guide portion disposed in the first chamber and configured to guide the recording material conveyed from the fixing portion to the cooling portion through the communication port, a blowing fan disposed above the guide portion in the first chamber and configured to blow air onto the guide portion from above, and an exhaust fan configured to exhaust the air blown from the blowing fan via the communication port to the second chamber, the exhaust fan being disposed upstream of the cooling portion in the conveying direction of the recording material in the second chamber.

Further features of the present invention will become apparent from the following description of exemplary embodiments with reference to the attached drawings.

### BRIEF DESCRIPTION OF THE DRAWINGS

FIG. 1 is a schematic view showing an ink jet recording apparatus.

FIG. 2 is a schematic view showing a fixing module.

FIG. 3 is a schematic view showing a recording material conveyance unit.

FIG. 4 is a perspective view showing an upper guide unit in a closed state.

FIG. 5 is a perspective view showing the upper guide unit in an open state.

FIG. 6 is a schematic view showing a cooling module.

FIG. 7 is a cross-sectional view showing a cooling portion of the cooling module.

FIG. 8A is a view for describing an air volume of airflow.

FIG. 8B is a view for describing a wind speed of airflow.

### DESCRIPTION OF THE EMBODIMENTS

### Ink Jet Recording Apparatus

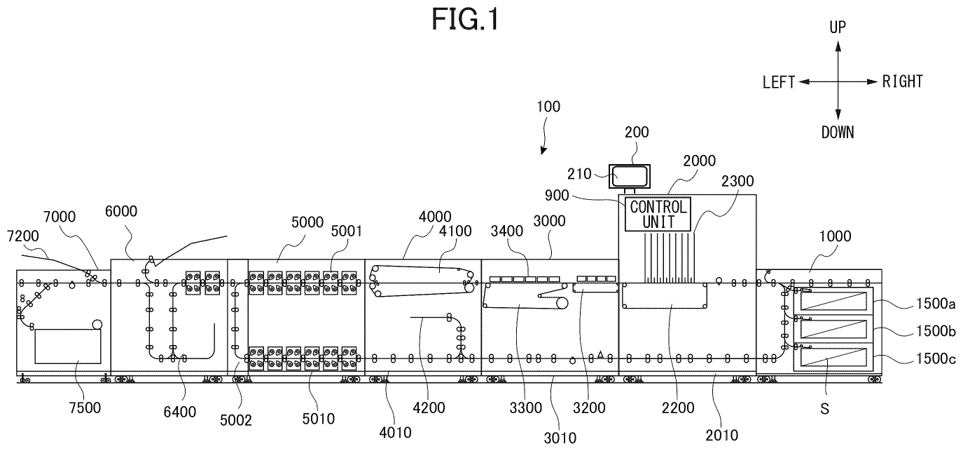

Hereinafter, an embodiment of the present invention will be described with reference to the drawings. First, an ink jet recording apparatus according to the present embodiment will be described with reference to FIG. 1. An ink jet recording apparatus 100 according to the present embodiment is a so-called sheet-fed ink jet recording apparatus that forms an image on a recording material using ink and reaction liquid based on image information input from an external device such as a computer or a document reading apparatus. The recording material may be any recording material capable of receiving ink, such as paper, such as plain paper or cardboard, plastic film, such as recording material for overhead projectors, specially shaped sheets, such as envelopes or index paper, and cloth.

In the present specification, the side on which a user stands when operating the ink jet recording apparatus 100 is referred to as the “front” and the opposite side is referred to as the “rear”. Moreover, the left side as viewed from the front is referred to as the “left”, and the right side as viewed from the front is referred to as the “right”. FIG. 1 shows the ink jet recording apparatus 100 as viewed from the front side.

As shown in FIG. 1, the ink jet recording apparatus 100 includes a feeding module 1000, a printing module 2000, a drying module 3000, a fixing module 4000, a cooling module 5000, a reversing module 6000, and a stacking module 7000. A recording material S supplied from the feeding module 1000 is subjected to various processes while being conveyed along a conveyance path in each module, and is finally discharged to the stacking module 7000.

The feeding module 1000, the printing module 2000, the drying module 3000, the fixing module 4000, the cooling module 5000, the reversing module 6000, and the stacking module 7000 each have a separate casing, and the ink jet recording apparatus 100 may be formed by connecting these casings. For example, a casing 2010 of the printing module 2000 and a casing 3010 of the drying module 3000, the casing 3010 and a casing 4010 (first casing) of the fixing module 4000, and the casing 4010 and a casing 5010 (second casing) of the cooling module 5000 are connected such that the recording material S can be delivered between each of the casings. In the present embodiment, the feeding module 1000, the printing module 2000, the drying module 3000, the fixing module 4000, the cooling module 5000, the reversing module 6000, and the stacking module 7000 may be disposed in one casing.

The feeding module 1000 includes cassettes 1500a, 1500b, and 1500c for accommodating the recording materials S. The cassettes 1500a to 1500c are provided to be capable of being pulled out toward the front side in order to accommodate the recording materials S therein. The recording materials S are fed one by one from each of the cassettes 1500a to 1500c by a separation belt and a conveyance roller, and conveyed to the printing module 2000. The number of cassettes 1500a to 1500c is not limited to three, but may be one, two, or four or more.

The printing module 2000 includes a pre-imaging conveyance unit (not shown), a print belt unit 2200, and a recording portion 2300. The recording material S conveyed from the feeding module 1000 is conveyed to the print belt unit 2200 after an inclination or a position of the recording material S is corrected by the pre-imaging conveyance unit. The recording portion 2300 is disposed at a position opposite to the print belt unit 2200 with respect to the conveyance path of the recording material S. The recording portion 2300 forms an image by ejecting ink onto the recording material S using a plurality of recording heads from above the recording material S conveyed by a belt. A plurality of recording heads for ejecting ink are arranged in the conveying direction of the recording material S. In the present embodiment, there are a total of five line-type recording heads which corresponds to the four colors of yellow (Y), magenta (M), cyan (C), and black (Bk), and the reaction liquid. The recording material S is conveyed by the print belt unit 2200, securing a clearance between the recording material S and the recording head.

The number of ink colors and the number of recording heads are not limited to the above-mentioned five. The ink jet method can employ a method using a heating element, a method using a piezoelectric element, a method using an electrostatic element, a method using a micro electro mechanical systems (MEMS) element, or the like. Ink of each color is supplied from an ink tank (not shown) to the recording head via an ink tube. The ink contains “0.1% by mass to 20.0% by mass” of a resin component based on the total mass of the ink, water, a water-soluble organic solvent, a coloring material, wax, additives, and the like.

The recording material S on which an image is formed by the recording portion 2300 is detected by an in-line scanner (not shown) disposed on the downstream side of the recording portion 2300 in the conveying direction of the recording material S as it is conveyed by the print belt unit 2200. Here, the misalignment and color density of the image formed on the recording material S are detected, and based on this image misalignment and color density, the images and densities to be formed on the subsequent recording materials S are corrected.

In the present embodiment, the printing module 2000 includes a control unit 900, and the control unit 900 controls the entire ink jet recording apparatus. The control unit 900 has, for example, a central processing unit (CPU), a read only memory (ROM), and a random access memory (RAM). The ROM and RAM store various programs such as image forming jobs, and various types of data such as image data. The CPU can execute an image forming program stored in the ROM or the RAM to operate the ink jet recording apparatus 100 to form an image. The RAM can temporarily store results of calculations performed while various programs are being executed.

Furthermore, the printing module 2000 is provided with an operation unit 200. For example, the operation unit 200 has a liquid crystal display unit 210 capable of displaying various types of information, and the liquid crystal display unit 210 can display various programs and various types of data, or various indications such as the end of an image forming job and the occurrence of an error. The operation unit 200 may be, for example, a touch panel capable of receiving inputs for starting various programs such as an image forming job, inputs of various types of data, and the like in response to touch operations by the user. Incidentally, the above-mentioned inputs for starting the various programs and inputs of various types of data are not limited to those input from the operation unit 200, but may be input from an external device such as a computer.

The drying module 3000 dries the recording material S by blowing hot air onto the recording material S on which an image has been formed. The drying module 3000 has a decoupling portion 3200, a drying belt unit 3300, and a hot air blowing unit 3400. The drying module 3000 reduces the liquid content of the ink applied to the recording material S in order to improve the fixation of the ink to the recording material S by the subsequent fixing module 4000.

The recording material S on which the image has been formed is conveyed to the decoupling portion 3200 disposed in the drying module 3000. In the decoupling portion 3200, a frictional force is generated between the recording material S and the belt by the wind pressure of air blown from above the decoupling portion 3200, and the recording material S is conveyed by the belt. In this way, the recording material S placed on the belt is conveyed by frictional force, thereby preventing the recording material S from shifting as it is conveyed between the print belt unit 2200 and the decoupling portion 3200.

The recording material S conveyed from the decoupling portion 3200 is conveyed by the drying belt unit 3300. The hot air blowing unit 3400 is disposed above the drying belt unit 3300, and hot air heated by a heater is blown onto the recording material S being conveyed by the drying belt unit 3300 from the hot air blowing unit 3400. Accordingly, the ink and the reaction liquid applied to the recording material S are dried. In this way, when the ink and the reaction liquid applied to the recording material S are heated by the drying module 3000, the ink becomes less absorbed at the points where the ink is applied to the recording material S, and the occurrence of so-called cockling, in which the recording material S stretches locally and becomes wrinkled, can be suppressed. As a heater for heating the air, for example, an electric heating wire or an infrared heater is preferable from the viewpoint of safety and energy efficiency. In addition, as a drying method, in addition to the method of blowing hot air, a method of irradiating the recording material S with electromagnetic waves (ultraviolet rays, infrared rays, and the like) or a conductive heat transfer method by contact with a heating element may be used, or a combination thereof may be used.

The fixing module 4000 has a fixing belt unit 4100. The fixing belt unit 4100 serving as a fixing portion fixes the ink onto the recording material S by passing the recording material S conveyed from the drying module 3000 between a upper belt unit and a lower belt unit which are heated.

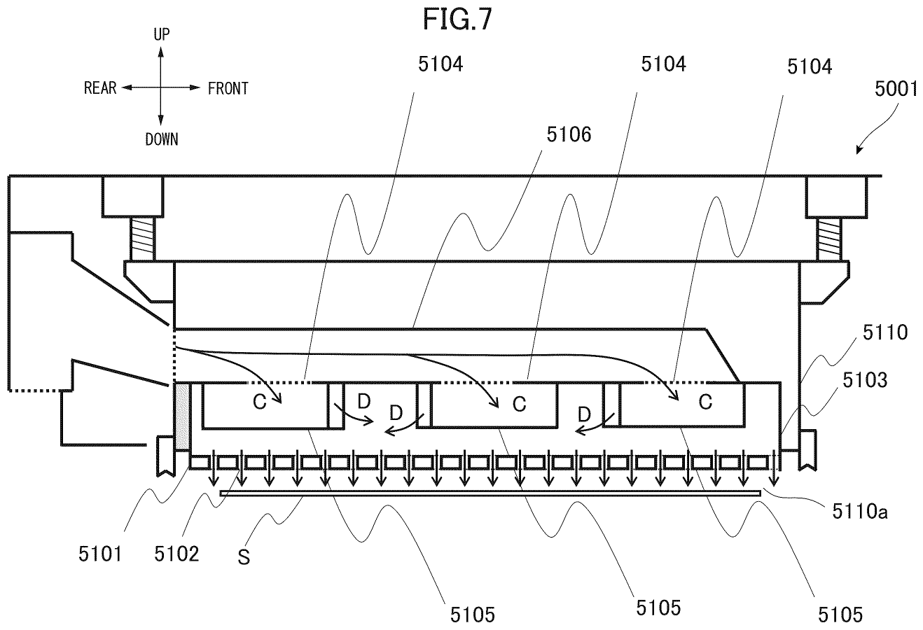

The cooling module 5000 has a plurality of cooling portions 5001, and the cooling portions 5001 cool the high-temperature recording material S conveyed from the fixing module 4000. The cooling portions 5001 are disposed on both sides of the conveyance path of the recording material S, and cool both sides of the recording material S. The cooling portion 5001 uses a fan to draw in air (outside air) from outside the casing 5010 into a cooling box, increasing the pressure inside the cooling box, and then blows the air out from the cooling box via a nozzle under pressure onto the recording material S to cool the recording material S (see FIG. 7 to be described below).

The cooling module 5000 is also provided with a conveyance path switching portion 5002. The conveyance path switching portion 5002 switches the conveyance path of the recording material S depending on a case where the recording material S is conveyed to the reversing module 6000 or a case where the recording material S is conveyed to a duplex conveyance path for double-sided printing in which images are formed on both sides of the recording material S.

The reversing module 6000 has a reverse portion 6400. The reverse portion 6400 reverses the front and back of the recording material S being conveyed, and changes the front and back orientation of the recording material S when it is discharged to the stacking module 7000. The stacking module 7000 has a top tray 7200 and a supporting portion 7500, and stacks the recording material S conveyed from the reversing module 6000.

During double-sided printing, the recording material S is conveyed to a lower conveyance path in the cooling module 5000 by the conveyance path switching portion 5002. Thereafter, the recording material S passes through a duplex conveyance path of the fixing module 4000, the drying module 3000, the printing module 2000, and the feeding module 1000, and is returned to the printing module 2000. The duplex conveyance portion of the fixing module 4000 is provided with a reverse portion 4200 that reverses the front and back of the recording material S. On the other side of the recording material S returned to the printing module 2000 on which the image is not formed, an image is formed using ink, and then the recording material S passes through the drying module 3000, the fixing module 4000, the cooling module 5000, and the reversing module 6000, and is discharged into the stacking module 7000.

### Fixing Module

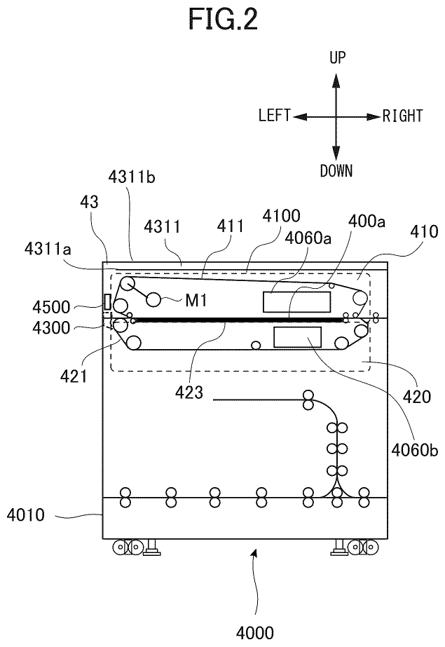

Next, the fixing module 4000 will be described in detail with reference to FIG. 2. As shown in FIG. 2, a fixing belt unit 4100 is provided on the upper part of the fixing module 4000. The fixing belt unit 4100 receives the recording material S discharged from the drying module 3000 and has a substantially linear sheet conveyance path 400a for conveying the recording material S to the cooling module 5000. At the exit of this sheet conveyance path 400a, that is, downstream of the fixing belt unit 4100 in the conveying direction of the recording material S, a conveyance guide unit 4300 is arranged. In the present embodiment, a blower unit 4500 is disposed above the conveyance guide unit 4300. The conveyance guide unit 4300 and the blower unit 4500 will be described later.

The fixing belt unit 4100 has an upper belt unit 410 and a lower belt unit 420. The upper belt unit 410 is disposed vertically above the lower belt unit 420. The upper belt unit 410 has an upper belt 411 serving as a first belt and a plurality of tension rollers around which the upper belt 411 is tensioned. The upper belt 411 rotates in accordance with one of the plurality of tension rollers driven by a drive motor MI serving as a drive source. The lower belt unit 420 has a lower belt 421 serving as a second belt, a plurality of tension rollers around which the lower belt 421 is tensioned, and a pad 423 having an arc-shaped curved surface. The pad 423 is disposed to form a fixing nip portion with the upper belt 411 via the lower belt 421. Further, the upper belt unit 410 and the lower belt unit 420 each have a heater (4060a, 4060b) serving as a heating portion for heating the upper belt 411 and the lower belt 421, respectively.

The fixing module 4000 also has an upper door unit 43 that can be opened upward. The upper belt unit 410 of the fixing belt unit 4100 is disposed inside the upper door unit 43, and the upper door unit 43 is configured to be able to be opened upward together with the upper belt unit 410. The recording material S is nipped and conveyed in the fixing nip portion between the upper belt unit 410 and the lower belt unit 420. The lower belt 421 is disposed opposite the upper belt unit 410 when the upper door unit 43 is located in the closed position. At this time, the recording material S is nipped and conveyed together with the upper belt 411. The pressure in the fixing nip portion is determined by the tension and thickness of the upper belt 411 and the curvature of the pad 423. When the pressure in the fixing nip portion is too high, there is a concern that the ink on the recording material S will adhere to the upper belt 411 and be peeled off from the recording material S, and therefore it is preferable that the pressure is “1 Pa or more and 2000 Pa or less”, and more preferably “1 Pa or more and 200 Pa or less”.

When the curvature of the pad 423 becomes large, the difference in the conveyance path between the front and back of the recording material S becomes large, and there is a concern that rubbing will occur between the recording material S and the belt. When the curvature of the pad 423 becomes large, there is a concern that the recording material S itself will memorize the curved shape and curl, and therefore it is desirable that the radius of curvature of the pad 423 is “50 mm or more”. From the viewpoint of manufacturing accuracy, it is desirable that the curvature of the pad 423 is a radius of curvature of “100,000 mm or less”. Due to these constraints, in the present embodiment, the tension of the upper belt 411 is set to 200 N, the thickness is set to “0.3 mm”, the curvature of the pad 423 is set to “30,000 mm”, and the nip pressure is set to “approximately 16 Pa”.

By employing such a configuration, it is possible to apply pressure uniformly even in a wide nip. Accordingly, even in a state in which the temperature of the upper belt unit 410 is set to the melting point of wax or the boiling point of water, heat can be sufficiently transferred to the recording material S by increasing the contact time between the recording material S and the upper belt unit 410. However, when the nip continues to be formed after the heat has been sufficiently transferred, the ink may adhere to the upper belt 411 and peel off from the recording material S, or the upper belt 411 and the recording material S may rub against each other, causing a disturbance to the image, and therefore a contact time that is too long is not preferable. Therefore, it is desirable that the time it takes for the leading edge of the recording material S to enter the nip entrance and emerge from the nip exit is “0.5 s to 4 s”. In the present embodiment, a pad 423 having a length of “900 mm” in the sheet conveying direction is used, the recording material S is conveyed at “700 mm/s”, and the time required for the leading edge of the recording material S to pass completely through the nip exit after entering the nip entrance is approximately “1.3 s”. In addition, since moisture is necessary for ink to penetrate the recording material S, it is preferable that the upper belt 411 and the lower belt 421 are made of a material that does not allow moisture to pass through such that when the recording material S becomes hot, the moisture evaporated from the surface of the recording material S does not escape through the upper belt 411 or the lower belt 421 that comes into contact with the recording material S.

In the fixing module 4000, a top surface partition plate 431 la for forming an air layer between itself and a top surface 4311b is arranged such that the top surface 4311b does not become too hot due to the heat generated by the heaters 4060a and 4060b. That is, the top surface partition plate 4311a forms a top surface duct 4311 between itself and the top surface 4311b. The top surface duct 4311 allows air outside the casing 4010 to pass through from the upstream end in the conveying direction. Since the heat generated by the heaters 4060a and 4060b is blocked by the air flowing inside the top surface duct 4311, the temperature of the top surface 4311b does not become high. Instead, the air in the top surface duct 4311 rises as heat from the heaters 4060a and 4060b is transferred to the top surface partition plate 4311a. In the present embodiment, the downstream end of the top surface duct 4311 in the conveying direction communicates with the space inside the casing 4010.

### Recording Material Conveyance Unit

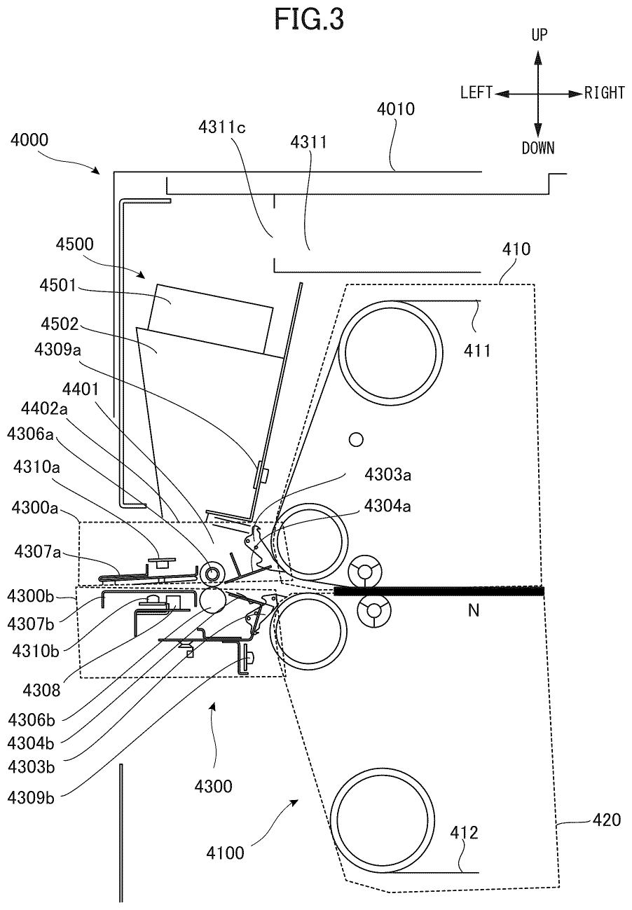

Next, the conveyance guide unit 4300 will be described with reference to FIGS. 3 to 5 while also referring to FIGS. 1 and 2. As shown in FIG. 3, the conveyance guide unit 4300 serving as a guide portion is arranged on the downstream side of the fixing nip portion N in the conveying direction of the recording material S, and conveys the recording material S that has passed through the fixing nip portion N to the cooling module 5000. The recording material S is separated from the upper belt 411 by an upper separation claw 4303a, and separated from the lower belt 421 by a lower separation claw 4303b, and is delivered to the conveyance guide unit 4300.

The conveyance guide unit 4300 includes an upper guide unit 4300a disposed on the upper belt unit 410 side, and a lower guide unit 4300b disposed on the lower belt unit 420 side. The upper guide unit 4300a has an upper belt exit guide 4304a, an upper conveyance roller 4306a, an upper conveyance guide 4307a, and an upper surface temperature detection sensor 4310a. The lower guide unit 4300b has a lower belt exit guide 4304b, a lower conveyance roller 4306b, a lower conveyance guide 4307b, and a lower surface temperature detection sensor 4310b. In the vertical direction, the upper belt exit guide 4304a and the lower belt exit guide 4304b, and the upper conveyance guide 4307a and the lower conveyance guide 4307b are disposed opposite to each other with a gap therebetween to allow the recording material S to pass therethrough. The upper conveyance roller 4306a and the lower conveyance roller 4306b are rotatably provided with the recording material S sandwiched therebetween.

In the present embodiment, the upper conveyance rollers 4306a and the lower conveyance rollers 4306b are disposed in the upper guide unit 4300a and the lower guide unit 4300b, respectively, but the present invention is not limited thereto. For example, the upper conveyance roller 4306a and the lower conveyance roller 4306b may be integrally arranged as a pair of roller pairs on either the upper guide unit 4300a or the lower guide unit 4300b.

The recording material S heated by the fixing belt unit 4100 is conveyed by the rotating upper conveyance roller 4306a and lower conveyance roller 4306b. At that time, the upper surface of the recording material S is guided by the upper belt exit guide 4304a and the upper conveyance guide 4307a serving as a first guide plate, and the lower surface of the recording material S is guided by the lower belt exit guide 4304 and the lower conveyance guide 4307b serving as a second guide plate, while the recording material S is conveyed. When the recording material S passes between the upper conveyance guide 4307a and the lower conveyance guide 4307b, a front surface temperature and a back surface temperature of the recording material S are detected by the upper surface temperature detection sensor 4310a and the lower surface temperature detection sensor 4310b, respectively. The upper surface temperature detection sensor 4310a and the lower surface temperature detection sensor 4310b are disposed to perform temperature control to check whether the temperature of the recording material S reaches a target temperature as the recording material S passes through the fixing belt unit 4100.

In the present embodiment, an upper belt temperature detection sensor 4309a that detects the temperature of the upper belt 411 in a non-contact manner, and a lower belt temperature detection sensor 4309b that detects the temperature of the lower belt 412 in a non-contact manner are disposed. The upper belt temperature detection sensor 4309a is provided to control the heater 4060a to maintain the temperature of the upper belt 411 at a target temperature. The lower belt temperature detection sensor 4309b is provided to control the heater 4060b to maintain the temperature of the lower belt 412 at a target temperature.

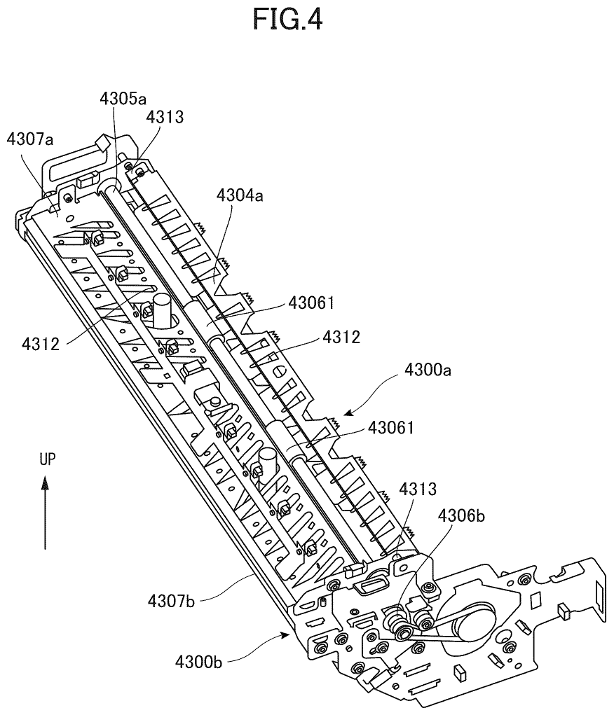

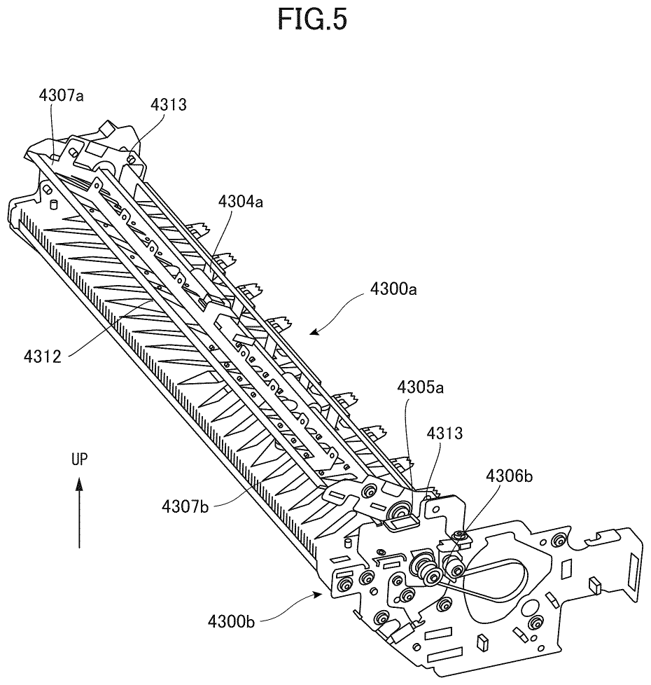

A recording material detection sensor 4308 capable of detecting the recording material S in a non-contact manner is disposed on the lower guide unit 4300b in order to detect a so-called jam in which the recording material S remains on the fixing belt unit 4100 or the conveyance guide unit 4300. In a case where the recording material S remains inside the conveyance guide unit 4300, the user needs to remove the remaining recording material S. Therefore, the upper guide unit 4300a is provided pivotably relative to the lower guide unit 4300b. FIG. 4 shows the upper guide unit 4300a in a closed state, and FIG. 5 shows the upper guide unit 4300a in an open state.

As shown in FIGS. 4 and 5, the upper guide unit 4300a is provided such that the downstream end side in the conveying direction can pivot in the vertical direction about a pivot axis shaft 4313 relative to the lower guide unit 4300b. When the upper guide unit 4300a is in the open state, the upper belt exit guide 4304a is located at a position away from the lower belt exit guide 4304b (see FIG. 3), the upper conveyance guide 4307a is located at a position away from the lower conveyance guide 4307b, and the upper conveyance roller 4306a is located at a position away from the lower conveyance roller 4306b. This opens the conveyance path for the recording material S, which is formed by the upper belt exit guide 4304a and the lower belt exit guide 4304b, the upper conveyance guide 4307a and the lower conveyance guide 4307b, and the upper conveyance roller 4306a and the lower conveyance roller 4306b. Therefore, the user can remove the recording material S remaining in the conveyance path when a jam occurs. Furthermore, the user can open the upper guide unit 4300a and clean mainly the inner surface sides (sides facing the conveyance path) of the upper conveyance guide 4307a and the lower conveyance guide 4307b. A plurality of ventilation holes 4312 through which air from the blower unit 4500 passes are formed in the belt exit guides (4304a, 4304b) and the conveyance guides (4307a, 4307b).

### Cooling Module

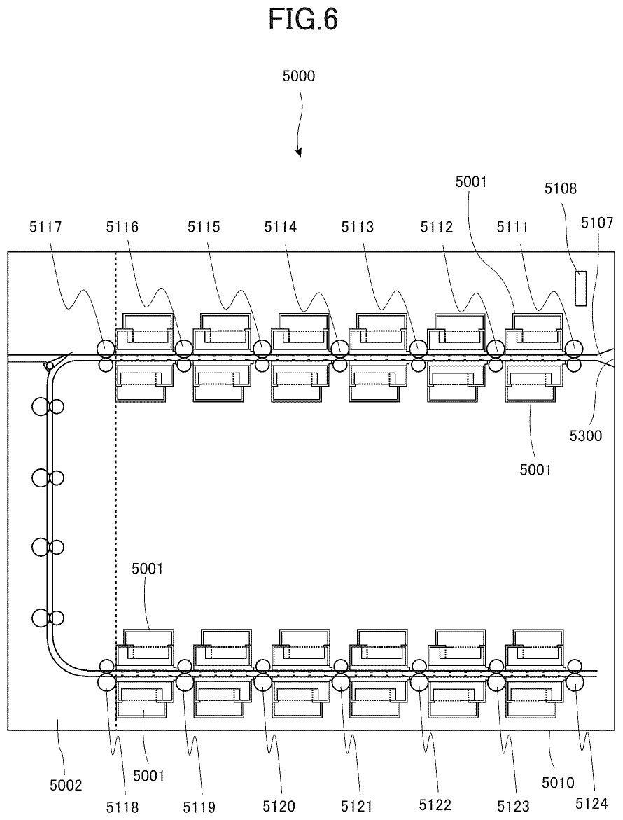

Next, the cooling module 5000 will be described with reference to FIGS. 6 and 7. FIG. 6 is a schematic view showing the cooling module 5000, and FIG. 7 is a cross-sectional view showing a cooling portion 5001 of the cooling module 5000. As shown in FIG. 6, the cooling module 5000 has a communication port 5300 formed on the upstream side in the conveying direction, which is open to allow the recording material S conveyed from the fixing module 4000 to be delivered, and an entrance guide 5107 is disposed at the communication port 5300. Additionally, within the casing 5010, upstream of the cooling portion 5001 in the conveying direction of the recording material S, an exhaust fan 5108 is disposed to exhaust air sent from the communication port 5300 into the casing 5010 in response to the air blown by a blowing fan. In addition, it is preferable that the entrance guide 5107 has a ventilation hole formed therein to ventilate the air in the vicinity of the belt exit guides (4304a, 4304b).

The cooling module 5000 has a plurality of cooling portions 5001, and the plurality of cooling portions 5001 are disposed on both sides of a conveyance path along which the recording material S is conveyed or side by side in the conveying direction of the recording material S. Further, in the conveying direction of the recording material S, conveyance roller pairs 5111, 5112, 5113, 5114, 5115, 5116, and 5117 for conveying the recording material S are disposed on both sides of the plurality of cooling portions 5001. The plurality of cooling portions 5001 cool both sides of the recording material S conveyed along the conveyance path by the conveyance roller pairs 5111 to 5117.

As described above, the cooling module 5000 is provided with the conveyance path switching portion 5002 in order to switch the conveyance path of the recording material S between a case where the recording material S is conveyed to the subsequent reversing module 6000 and a case where the recording material S is returned to the printing module 2000 for double-sided printing on the recording material S. In the cooling module 5000, a plurality of cooling portions 5001 and conveyance roller pairs 5118, 5119, 5120, 5121, 5122, 5123, and 5124 are also disposed on the duplex conveyance path that returns the recording material S to the printing module 2000.

As shown in FIG. 7, the cooling portion 5001 has a cooling guide 5101 disposed on the upstream side in the conveying direction. The cooling guide 5101 has a guide function when the recording material S passes through. In addition, a large number of nozzles 5102 are arranged on the guide surface of the cooling guide 5101. A box 5103 has a seamless box shape, and the cooling guide 5101 is fixed without any gaps to form a cooling box 5110. A cooling fan 5105 is arranged in the box 5103, and an air supply hole 5104 for supplying air to the cooling fan 5105 is formed. Furthermore, in the box 5103, a conveyance side air supply duct 5106 which functions as an air duct for supplying air to the cooling fan 5105 is arranged on the air supply hole 5104 side. The cooling fan 5105 blows air from the cooling box 5110. In other words, the cooling box 5110 functions as a duct (second duct) through which air is blown by the cooling fan 5105. The cooling box 5110 has an air outlet 5110a formed on the side of the conveyance path along which the recording material S is conveyed. The recording material S conveyed from the fixing module 4000 is cooled by the air blown from the cooling box 5110.

Incidentally, in the fixing module 4000 described above, the moisture or solvent in the ink applied onto the recording material S is heated in the fixing nip portion N and vaporizes, and tends to remain inside the casing 4010. Since vaporized moisture or solvent increases the humidity in an exit area 4401 (see FIG. 3) of the fixing nip portion N, dew condensation may occur when the temperature inside the casing 4010 drops. When dew condensation occurs, moisture or a solvent adheres to the belt exit guides (4304a, 4304b) and the conveyance guides (4307a, 4307b) shown in FIG. 3. When moisture or a solvent adheres to the belt exit guides (4304a, 4304b) or the conveyance guides (4307a, 4307b), there is a concern that the recording material S may become dirty or the recording material S may jam.

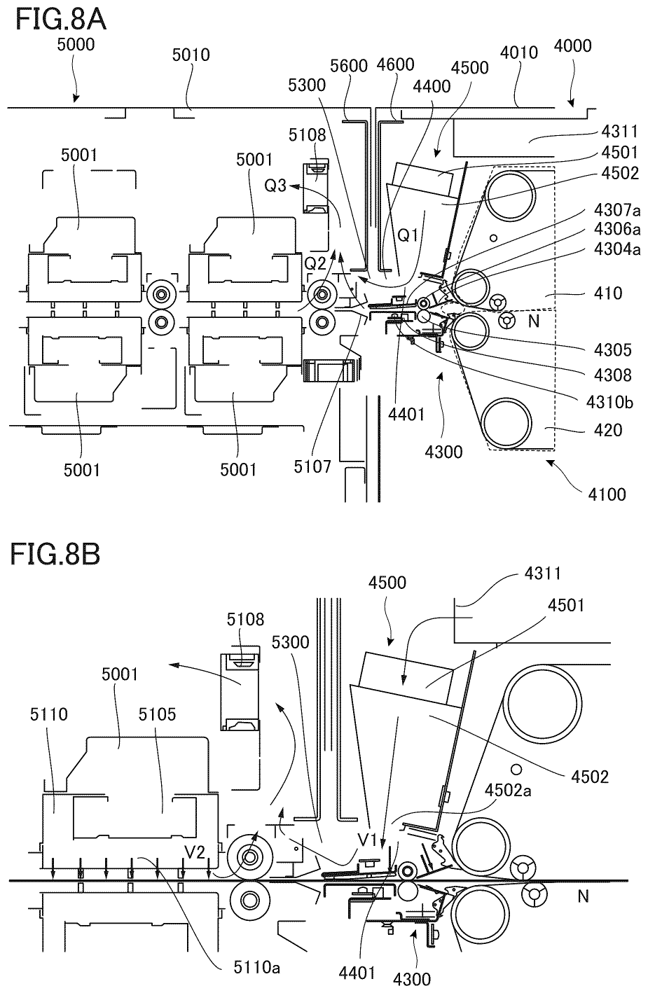

Therefore, in the present embodiment, in order to suppress the occurrence of dew condensation caused by the vaporization of moisture or a solvent in the ink, as shown in FIG. 3, the blower unit 4500 is disposed above the conveyance guide unit 4300, and the air inside the casing 4010 is exhausted outside the casing 4010 by the blower unit 4500. The blower unit 4500 will be described below with reference to FIG. 3, FIG. 8A, and FIG. 8B.

### Blower Unit

As shown in FIG. 3, the blower unit 4500 has a blowing fan 4501 and a blowing duct 4502 (first duct). The blowing duct 4502 has an air outlet 4502a formed on the conveyance guide unit 4300 side (guide portion side). In the present embodiment, the blowing fan 4501 takes in air discharged into the casing 4010 (inside the first casing) from a discharge port 4311c formed in the top surface duct 4311 described above, and blows the air from above onto the conveyance guide unit 4300 through the blowing duct 4502. By blowing air onto the conveyance guide unit 4300 from above, the air in the exit area 4401 of the fixing nip portion N is exhausted to the outside of the casing 4010. In the present embodiment, the air is discharged from the casing 4010 to the casing 5010 of the cooling module 5000.

As described above, the air in the top surface duct 4311 rises as heat from the heaters 4060a and 4060b is transferred to the top surface partition plate 4311a. Therefore, the air heated within the top surface duct 4311 is blown by the blowing fan 4501 onto the conveyance guide unit 4300. Therefore, it is possible to exhaust the high humidity air present in the exit area 4401 of the fixing nip portion N without cooling the belt exit guides (4304a, 4304b) and the conveyance guides (4307a, 4307b). Furthermore, since the belt exit guides (4304a, 4304b) and the conveyance guides (4307a, 4307b) are formed with ventilation holes 4312 (see FIG. 6), air from the blowing fan 4501 can easily flow into the exit area 4401 of the fixing nip portion N. In this way, ventilation of the air in the exit area 4401 of the fixing nip portion N is promoted, thereby making it easier to lower the humidity inside the casing 4010.

The blowing fan 4501 is driven (rotated) by a motor (not shown) controlled by the control unit 900 (see FIG. 1). In the present embodiment, the blowing fan 4501 is driven in a case where the upper belt 411 and the lower belt 421 are rotated, and is not driven in a case where the upper belt 411 and the lower belt 421 are not rotated. That is, the control unit 900 drive the blowing fan 4501 when the ink jet recording apparatus 100 is forming an image or is in a standby state, and does not drive the blowing fan 4501 when the ink jet recording apparatus 100 is in a sleep state. Here, the standby state refers to a awaiting state in which the ink jet recording apparatus 100 is ready to immediately start an image forming operation (image formation) on a recording material S in response to an input of an image forming job. The sleep state is a state in which power consumption is less than that in the standby state. In a case where the ink jet recording apparatus 100 is in a power-on state and a predetermined time has elapsed since the end of an image forming operation without an input of an image forming job, the ink jet recording apparatus 100 transitions to a standby state. Then, in a case where a predetermined time has elapsed from the standby state without an input of an image forming job, or in a case where a power saving mode is selected from the operation unit 200, the transition is made from the standby state to a sleep state.

### Air Volume

Next, the optimum relationship of airflow air volume for exhausting the air inside the casing 4010 to the casing 5010 side by the blower unit 4500 will be described with reference to FIG. 8A. As shown in FIG. 8A, the casings 4010 and 5010 have partition walls 4600 and 5600 that separate a first chamber in which the fixing belt unit 4100 is disposed and a second chamber in which the cooling portion 5001 is disposed from each other, and that have communication ports 4400 and 5300 that communicate between the first chamber and the second chamber such that the recording material S can pass through.

Air flowing in from the top surface duct 4311 by the blowing fan 4501 passes through the blowing duct 4502 and is blown onto the conveyance guide unit 4300 at an air volume “Q1”. The air volume “Q1” is the air volume of air blown from the blowing duct 4502 by the blowing fan 4501. In the present embodiment, in the cooling module 5000, the airflow from the cooling portion 5001 bounces back and is taken in by the exhaust fan 5108, thereby generating an airflow with an air volume “Q2” in the opposite direction to the airflow blown from the blowing duct 4502 by the blowing fan 4501. The exhaust fan 5108 is disposed at a higher position within the casing 5010 than the communication port 5300 in order to guide the airflow generated from the cooling portion 5001 and the airflow generated by the blowing fan 4501 toward the top of the casing 5010 when the air within the casing 4010 is drawn into the casing 5010 by the air blown from the blowing fan 4501.

In order to simultaneously exhaust the airflow of the blowing fan 4501 and the airflow of the cooling portion 5001 to the outside of the casing 5010, an air volume “Q3” of the exhaust fan 5108 is set to satisfy “Q3−Q2>Q1”. In this way, the air blown from the blowing fan 4501 can be exhausted to the outside of the casing 5010 by the exhaust fan 5108 without causing the high humidity air in the exit area 4401 of the fixing nip portion N to flow back or stagnate. In the present embodiment, the air volume “Q1” of the blowing fan 4501 required to ventilate the high humidity air in the exit area 4401 of the fixing nip portion N is, for example, about “0.3 m³/min”, and the air volume “Q2” of the cooling portion 5001 is, for example, about “1.0 m³/min”. Therefore, the air volume “Q3” of the exhaust fan 5108 is set to, for example, “1.5 m³/min”.

### Wind Speed

Next, the optimum relationship of the airflow wind speed for exhausting the air inside the casing 4010 to the casing 5010 side by the blower unit 4500 will be described with reference to FIG. 8B. In the present embodiment, as described above, the air blown by the blowing fan 4501 through the blowing duct 4502 toward the conveyance guide unit 4300 is intended to ventilate the exit area 4401 of the fixing nip portion N without causing the air to stagnate. Therefore, it is sufficient that a wind speed (V1) of the air blown by the blowing fan 4501 is a wind speed capable of ventilating the air in the exit area 4401 of the fixing nip portion N. On the other hand, the air blown toward the recording material S by the cooling portion 5001 is intended to efficiently cool the high-temperature recording material S conveyed from the fixing module 4000. Therefore, it is preferable that a wind speed (V2) of the air blown by the cooling portion 5001 is as high as possible such that the efficiency of heat transfer to the recording material S is increased. In the present embodiment, the wind speed (V1) of the air blown by the blowing fan 4501 is the wind speed at the air outlet 4502a (first air outlet) of the blowing duct 4502. The wind speed (V2) of the air blown by the cooling portion 5001 is the wind speed at the air outlet 5110a (second air outlet) of the cooling box 5110.

In the present embodiment, in consideration of the above points, the wind speed (V1) of the air blown by the blowing fan 4501 and the wind speed (V2) of the air blown by the cooling portion 5001 are set to satisfy “V1<V2”. Here, if the relationship between the wind speed (V1) of the air blown by the blowing fan 4501 and the wind speed (V2) of the air blown by the cooling portion 5001 is assumed to be “V1>V2”, there is a concern that the air blown by the blowing fan 4501 will cool the fixing belt unit 4100 or hinder the cooling function of the cooling portion 5001 in the cooling module 5000. In the present embodiment, a wind speed of, for example, “0.3 m/s” is required to ventilate the air in the exit area 4401 of the fixing nip portion N. In this case, the wind speed (V1) of the air blown by the blowing fan 4501 is set to “2.0 m/s”, and the wind speed of the air blown by the cooling portion 5001 is set to “33.0 m/s” since the purpose is to cool the recording material S.

### Guide Coating

The main components of the substances that volatilize from the ink used in the present embodiment are water and a water-soluble solvent (glycerin). Here, the surface tension of water is generally “72.75 mN/m”, and the surface tension of glycerin is “63.4 mN/m”. Hitherto, materials such as stainless steel have often been used for the belt exit guides (4304a, 4304b) and the conveyance guides (4307a, 4307b), and the surface free energy of stainless steel is “700 to 1100 mN/m”. In this case, since the surface free energy of the above-mentioned guide is greater than that of water or glycerin, the contact angle of the water or glycerin condensed on the guide becomes small, and the water or solvent spreads over the surface of the guide and is likely to form a liquid pool on the guide surface. In addition, while solvents such as glycerin have a high boiling point and are difficult to volatilize, once water vapor containing the solvent condenses, it is less likely to volatilize than water alone, and the dew condensation is difficult to eliminate. Furthermore, since solvents such as glycerin have a higher viscosity than water, when liquid pools due to dew condensation adhere, the resistance to conveyance by the guide increases.

Therefore, in the present embodiment, the belt exit guides (4304a, 4304b) and the conveyance guides (4307a, 4307b) are coated with fluorine. The surface free energy of the fluorine coating is 18.5 mN/m, which is smaller than the surface free energy of water and glycerin. Therefore, the contact angle with droplets of water, glycerin, and the like that condense on the guides becomes larger, thereby making it difficult for the water or glycerin that condenses on the guides to spread. In this case, water or glycerin that has adhered to the guide due to wind, vibration, its own weight, rubbing of the recording material S, or the like, can be easily removed, thereby eliminating dew condensation and making it difficult for a liquid pool to form. Therefore, it is possible to prevent an increase in the resistance to conveyance by the guide caused by dew condensation of a highly viscous solvent such as glycerin.

In addition, in the present embodiment, in order to ensure that the surface free energy of the substance employed for the guide surface is smaller than the surface tension of glycerin, under a condition that “a substance has a surface free energy of 60 mN/m or less”, a fluorine coating is employed from among substances that satisfy the condition, but the present invention is not limited to fluorine coating. For example, the guide may be formed of a substance that satisfies the above condition, such as PFA or a resin material, or the guide surface may be coated with such a substance.

In the present embodiment, it is preferable that the upper conveyance roller 4306a has a shape in which a plurality of roller portions 43061 are arranged at intervals on the rotation shaft such that the air blown by the blowing fan 4501 can easily flow over the outer surface of the upper conveyance guide 4307a (see FIG. 4). In addition, it is preferable that the outer surface of the upper conveyance guide 4307a is provided with a plurality of ribs (not shown) protruding from the outer surface along the conveying direction of the recording material S at intervals in the width direction in order to direct the flow of the air blown by the blowing fan 4501 toward the casing 5010.

As described above, in the present embodiment, the blower unit 4500 is arranged above the conveyance guide unit 4300 to blow air onto the conveyance guide unit 4300 which guides the recording material S heated by the fixing belt unit 4100 to the cooling module 5000. Since the blower unit 4500 blows air onto the conveyance guide unit 4300 from above, the air containing the moisture or solvent in the ink tends to flow toward the cooling module 5000 from the space above the conveyance guide unit 4300 in which the air containing the moisture or solvent in the ink vaporized as the recording material S is heated tends to accumulate. The air containing the moisture or solvent in the ink is taken in by the exhaust fan 5108 provided in the cooling module 5000, making it less likely to flow toward the fixing belt unit 4100 and more likely to flow toward the cooling module 5000, and can be exhausted to the outside from the cooling module 5000. In this way, since air containing the moisture or solvent in the ink is less likely to accumulate in the space above the conveyance guide unit 4300, the moisture or solvent in the ink is less likely to adhere to the conveyance guide unit 4300.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-044088, filed Mar. 19, 2024, which is hereby incorporated by reference herein in its entirety.

What is claimed is:

1. An ink jet recording apparatus comprising:
a fixing portion including a first belt, a second belt contacting the first belt to form a nip portion, and a heating portion configured to heat the first belt, and configured to fix the ink to a recording material on which an image is formed with ink while conveying and heating by the nip portion;
a cooling portion disposed downstream of the fixing portion in a conveying direction of the recording material and including a cooling fan configured to blow air onto the recording material conveyed from the fixing portion to cool the recording material;
a partition wall separating a first chamber in which the fixing portion is disposed and a second chamber in which the cooling portion is disposed from each other, and including a communication port configured to communicate between the first chamber and the second chamber such that the recording material passes through;
a guide portion disposed in the first chamber and configured to guide the recording material conveyed from the fixing portion to the cooling portion through the communication port;
a blowing fan disposed above the guide portion in the first chamber and configured to blow air onto the guide portion from above; and
an exhaust fan configured to exhaust the air blown from the blowing fan via the communication port to the second chamber, the exhaust fan being disposed upstream of the cooling portion in the conveying direction of the recording material in the second chamber.

2. The ink jet recording apparatus according to claim 1, further comprising:
a first duct in which a first air outlet is formed on a side of the guide portion and the blowing fan is arranged to blow air from the first air outlet; and
a second duct in which a second air outlet is formed on a side of a conveyance path along which the recording material is conveyed and the cooling fan is arranged to blow air from the second air outlet,
wherein a wind speed of the air blown from the first air outlet by the blowing fan is greater than a wind speed of the air blown from the second air outlet by the cooling fan.

3. The ink jet recording apparatus according to claim 1, further comprising:
a first casing; and
a second casing connected to the first casing on a downstream side in the conveying direction such that the recording material is deliverable,
wherein the partition wall includes a first partition wall provided in the first casing and a second partition wall provided in the second casing, and the communication port is formed in the first partition wall and the second partition wall, and
wherein the fixing portion and the guide portion are accommodated in the first casing, and the cooling portion is accommodated in the second casing.

4. The ink jet recording apparatus according to claim 3, further comprising:
a top surface duct arranged between a top surface and the fixing portion in the first casing and configured to pass outside air from an outside of the first casing to cool the top surface,
wherein the blowing fan is configured to take in air discharged into the first casing from a discharge port formed in the top surface duct and blow the air onto the guide portion.

5. The ink jet recording apparatus according to claim 1,
wherein the guide portion includes a first guide plate that guides an upper surface of the recording material and a second guide plate that guides a lower surface of the recording material, and
a surface of the first guide plate is coated with fluorine.

6. The ink jet recording apparatus according to claim 1, further comprising:
a drive source configured to drive the first belt; and
a control unit configured to control the drive source and the blowing fan,
wherein the control unit is configured to control the blowing fan such that the blowing fan is driven in a standby state in which image formation is awaited in a state in which the first belt is rotated, and the blowing fan is not driven in a sleep state in which the first belt is not rotated and power consumption is less than power consumption in the standby state.
